(19) United States
(12) Patent Application Publication
(10) Pub. No.: US 2003/0057276 A1
(43) Pub. Date: Mar. 27, 2003

(54) Method and system for non-contact automated verification of the correctness of the identity of an item having an associated primary identifier

(75) Inventors: Lawrence Appalucci, Villanova, PA (US); Eric Eckstein, Merion Station, PA (US); Gary Thomas Mazoki, Sewell, NJ (US); David K. Shoemaker, Kennett Square, PA (US)

Correspondence Address: AKIN GUMP STRAUSS HAUER & FELD L.L.P., ONE COMMERCE SQUARE, 2005 MARKET STREET, SUITE 2200, PHILADELPHIA, PA, 19103-7013, US

(73) Assignee: Checkpoint Systems, Inc.

(21) Appl. No.: 10/235,082

(22) Filed: Sep. 5, 2002

Related U.S. Application Data
(60) Provisional application No. 60/324,442, filed on Sep. 24, 2001.

(51) Int. Cl. G06K 5/00; G06K 19/06

(52) U.S. Cl. 235/382

(57) ABSTRACT

A method for automated identification of the correctness of the identity of an item which has an associated primary identifier of a first machine readable type includes associating a separate, secondary identifier with the item prior to the time that verification of the correctness of the item is sought, the secondary identifier being of a second, machine readable, non-contact type. The primary identifier is read using a machine to provide primary identification information. The secondary identifier is also read using a machine to provide secondary identification information. The primary identification information and the secondary identification information are compared and the identity of the item is confirmed only if the comparison results in a match.

### CROSS-REFERENCE TO RELATED APPLICATIONS

The present application claims the benefit of U.S. Provisional Patent Application No. 60/324,442, filed Sep. 24, 2001 and entitled “Method and System for Determining Whether an Item is Correctly Identified by an Associated Primary Identifier”, the entire subject matter of which is incorporated herein by reference.

### BACKGROUND OF THE INVENTION

The present invention relates generally to verification of the identity of an item and, more particularly, to an automated method and system for verifying whether an item is correctly identified by an associated primary identifier.

In the present application, the term “item” should be considered to be read in its broadest sense. That is, the term item should be considered to mean a product, article, good, and the like, including consumer goods, industrial goods, commercial goods, and virtually any other type of property capable of moving from one location to another. The term item also includes access control devices such as a key card, identification card, ticket, such as an airline, train, bus or other ticket used for a conveyance, a ticket used for entry into a facility such as a theater or concert and the like. In other words, the term item should be construed to cover anything which includes a machine readable primary identifier either on or associated with the item or its packaging.

In the present application, the term “primary identifier” should also be construed in its broadest sense. That is, the term primary identifier means any type of identification scheme, device, indicia, or the like, generally in a machine readable format, which may be placed on or in an item, placed on the packaging for an item, or may otherwise be associated with an item. A typical well-known primary identifier is a standard or enhanced barcode label of the type which may be used for identifying an item either during a manufacturing process, during storage or shipment, at the time of checkout from a retail or other facility or thereafter. Other types of primary identifiers include, but are not limited to magnetic stripes, radio frequency identification tags (with or without a chip or integrated circuit) and the like. A primary identifier is typically one which is readily apparent and which can be conveniently read, usually in a non-contact manner by a machine, such as a barcode scanner, magnetic card swiper, radio frequency interrogator or the like for the purpose of automated identification of the item with which the primary identifier is associated.

Presently, most, if not all, goods produced and/or sold include an associated primary identifier, typically a barcode label, which is placed on the item in a prominent location or is incorporated on or in the packaging for the item, usually at the time the item is produced. Such a primary identifier permits convenient machine reading of the barcode and tracking of the item as it passes from the manufacturer to a distributor and finally to a retailer by merely reading the primary identifier, usually at a checkpoint or gateway as the item passes from one place to another. In the case of an item including a barcode label, the barcode label may be conveniently read using a well-known optical scanner. The scanner reads and decodes the barcode label and sends the decoded information to a computer or other device to facilitate tracking of the location of the item. Once the item reaches the shelf of a retail facility the barcode label may be read again by a scanner at a checkout counter for automated purchase of the item as well as automated updating of the inventory or other accounting of such items within the retail facility.

While the use of a primary identifier on or associated with an item is desirable, under some circumstances, the use of a primary identifier can be detrimental. For example, if a thief wishes to steal an item, particularly an expensive item, from a retail facility, the thief can alter a primary identifier or remove the correct primary identifier, particularly a barcode label, from the item and substitute a primary identifier, such as a barcode label, from a less expensive item. In this manner, the thief may present the item for scanning at a checkout counter where the scanning would result in a price, which would be substantially less than the actual price of the item. Similarly, where an item, such as an identification card, is used for obtaining access, a counterfeit primary identifier may be used to permit access to an unauthorized person.

### BRIEF SUMMARY OF THE INVENTION

Briefly stated, the present invention, in one form, comprises a method for automated verification of the correctness of the identity of an item which has an associated primary identifier of a first machine readable type. The method comprises the steps of: associating a separate, secondary identifier with the item prior to the time that verification of the correctness of the identity of the item is sought, the secondary identifier being of a second, machine readable, non-contact type; reading the primary identifier using a machine to provide primary identification information; reading the secondary identifier using a machine to provide secondary identification information; comparing the primary identification information and the secondary identification information; and confirming the identity of the item only if the comparison results in a match.

The present invention further comprises a system for automated verification of the identification of an item which has an associated primary identifier of a first machine readable type and an associated separate, secondary identifier of a second machine readable, non-contact type. The system comprises a first reader for reading the primary identifier and generating an output signal containing primary identification information. A second reader reads the secondary identifier and provides an output signal containing secondary identification information. A comparitor receives and compares the output signal from the first reader and the output signal of the second reader and generates an output signal based upon the result of the comparison.

The present invention further comprises an item which has an associated primary identifier of a first machine readable type and an associated, separate, secondary identifier of a second, machine readable, non-contact type, the secondary identifier being associated with the item at an undisclosed, non-apparent location on or within the item or its packaging. Verification of the identity of the item may be obtained by reading the primary identifier to provide primary identification information, reading the secondary identifier to provide secondary identification information, comparing the primary identification and the secondary identification information and confirming the identity of the item only if the comparison results in a match.

### BRIEF DESCRIPTION OF THE SEVERAL VIEWS OF THE DRAWINGS

The foregoing summary, as well as the following detailed description of preferred embodiments of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown.

In the drawings:

FIG. 1 is a perspective view of a first item (television) having an associated first identifier and an associated second identifier in accordance with a first preferred embodiment of the present invention;

FIG. 2 is a perspective view of a different item (identification card) having an associated primary identifier and an associated secondary identifier in accordance with a second preferred embodiment of the present invention;

FIG. 3 is a perspective view of a different item (event ticket) including an associated primary identifier and an associated secondary identifier in accordance with a third preferred embodiment of the present invention;

FIG. 4 is a perspective view of an item contained within packaging with an associated primary identifier and an associated secondary identifier in accordance with a fourth preferred embodiment of the present invention;

FIG. 5 is a schematic representation of a retail checkout counter illustrating the presence of a first reader for reading a primary identifier and a second reader for reading a secondary identifier in accordance with a preferred embodiment of the present invention;

FIG. 6 is a schematic block diagram of a system for reading a primary identifier and a secondary identifier associated with an item in accordance with a preferred embodiment of the present invention; and

FIG. 7 is a schematic block diagram representation of an integrated device for reading both a primary identifier and a secondary identifier in accordance with a preferred embodiment of the present invention.

### DETAILED DESCRIPTION OF THE INVENTION

The present invention comprises a method and system for determining, in an automated manner, whether an item is correctly identified by an associated primary identifier. With the present invention, a separate, secondary identifier is also associated with the item. Preferably, the secondary identifier is of a different type than the primary identifier and is incorporated on or within the item at an unapparent, undisclosed location, preferably during the time that the item is being produced. Alternatively, the secondary identifier may be placed on or within the item after production has been completed. The secondary identifier could also be secured within or to the packaging for an item or could otherwise be associated with the item such as by way of a hanging tag or being integrated into the woven label of a garment, or the like. The manner in which the secondary identifier is associated with the item should not be considered to be a limitation on the present invention. However, it is preferable that the presence and location of a secondary identifier not be openly disseminated.

With the present invention, a reader reads the secondary identifier slightly before, slightly after or substantially simultaneously with the reading of the primary identifier associated with the item. The reader of the secondary identifier decodes the read identification information and sends the decoded information to a comparator. The reader of the primary identifier also decodes the read primary identification information and sends the decoded information to the same comparator. The readers can be integrated into a single unit or be completely separate devices. The comparator receives the decoded information from the primary and secondary readers and determines if there is a valid match verses a predetermined database. If the comparison indicates a match then the secondary identifier effectively confirms the identity of the item as being in accordance with the identity specified by the primary identifier and a positive output signal is generated. If the comparison results in no match then it is likely that the item is not correctly identified by the primary identifier and a different output signal is generated.

A positive output signal generated by the comparator can be used for multiple functions. If the comparison of the decoded information read from the primary and secondary identifiers results in a match, the output for example, could activate a deactivation device to allow an identifier or an EAS label to be disabled. In the case of the identifier being deactivated, this allows for the one time use of the identifier and further safeguards the item identification. If the comparison of the primary and secondary identifiers does not match, the output, for example could send a signal to activate an alarm, such as a silent alarm to allow an attendant to address the event or for example, activate a CCD camera to capture the event.

The secondary identifier could comprise any suitable identification scheme, device, indicia or the like. However, it is preferred that the secondary identifier be one which may be conveniently machine read on a non-contact basis without being in close proximity to the reader and without being in direct line-of-site with the reader. An example of a preferred secondary identifier is a device which may be read by radio frequency or magnetics. For example, the secondary identifier could comprise a radio frequency (EAS) tag (single information bit) or a radio frequency identification tag (multiple information bits) of the type which includes a chip or integrated circuit or of the type which does not include a chip or integrated circuit. Alternatively, the secondary identifier could comprise a magnetic-type identification tag. Radio frequency tags, radio frequency identification tags and magnetic-tags are well known in the art and are available from a variety of manufacturers. As previously noted, it is preferable that the secondary identifier be placed at an undisclosed location within the item, preferably during the time that the item is being produced. Alternatively, the secondary identifier could be placed within or on the item at a later time or could be placed within or on the packaging for the item. Preferably, the reader employed for reading the secondary identifier has a range sufficient for a proper reading of the secondary identifier, but yet, not so great that the reader would be confused by reading secondary identifiers from other items. The range of the reader of the secondary identifier should be about the same as the range of the reader of the primary identifier but, preferably, at least slightly greater. The reader employed for reading the secondary item is also of the type well-known to those of ordinary skill in the art and available from a variety of manufacturers.

1. Retail Sales

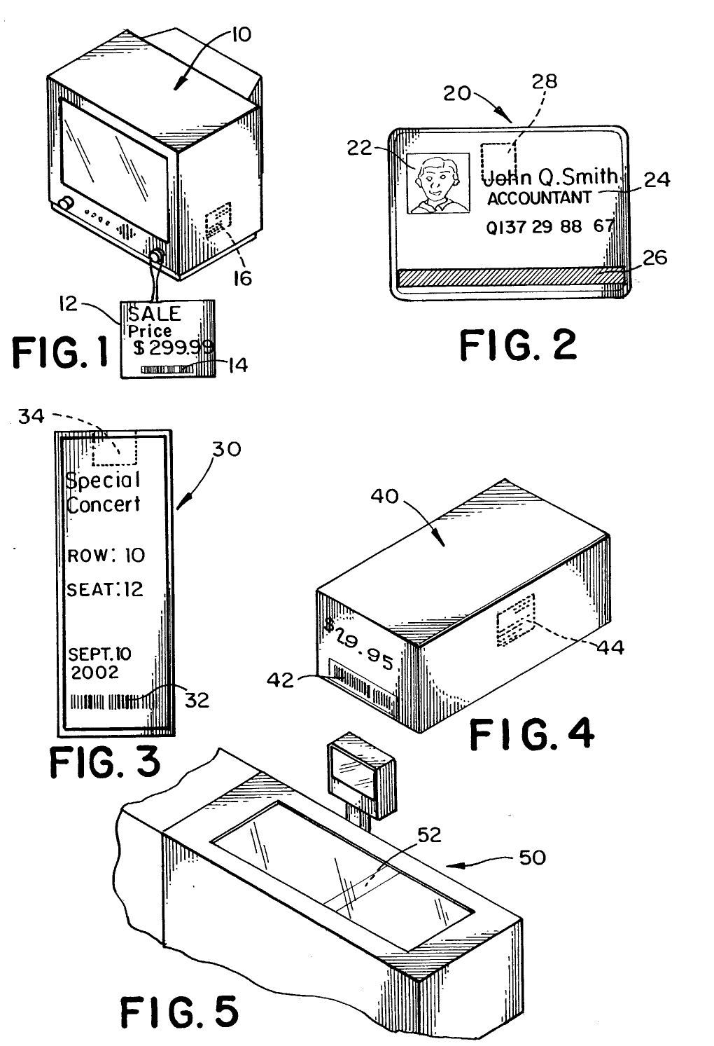

As discussed briefly above, barcode labels are in widespread use in connection with many products, such as consumer products. FIG. 1 illustrates a first item which in the present embodiment is in the form of a portable television 10. Secured to the television 10 is a hang tag 12 which includes pricing and other information and a barcode 14. The barcode 14 contains encoded information concerning the identity of the television 10 such that when the barcode is effectively scanned at the time of purchase, the current price of the television 10 will be identified. Thus, the barcode 14 serves as a primary machine readable identifier of the identity of the television 10. Embedded within the television 10, at a hidden location, is a radio frequency identification tag 16 of a type well known to those of ordinary skill in the radio frequency identification art. The radio frequency identification tag 16 is preferably inserted within the television 10 during the manufacturing process. Alternatively, the radio frequency identification tag 16 may be inserted into the television 10 at a later time, such as when the television 10 arrives at a retail facility. Regardless of when the radio frequency identification tag 16 is installed, the radio frequency identification tag 16, when read or interrogated outputs a predetermined encoded signal which is unique or at least semi-unique.

FIG. 4 illustrates an item or group of items which are sold in a single package such as an elongated cardboard box 40. One of the panels of the box 40 contains identification information as well as the price of the box of items. That same panel also contains a barcode label 42 which functions as a primary identifier of the item or items within the box 40. A radio frequency identification tag 44 which serves as a secondary identifier, is also located within the box 40 at a hidden, undisclosed location.

FIG. 5 illustrates a checkout counter 50 of a type typically used in a retail or other such facility. The checkout counter 50 includes a barcode scanner 52 of a type well known to those skilled in the art for reading a barcode such as the barcode 14 associated with television 10 or the barcode 42 associated with the items in box 40 to facilitate the purchase of the items. The checkout counter 50 further includes a reader in the form of a radio frequency interrogator (not shown in FIG. 5) which is not readily apparent to a user of the checkout counter 50. The radio frequency interrogator is employed for interrogating a secondary identifier such as the radio frequency tag 16 located within the television 10 or the radio frequency tag 44 located within the box 40.

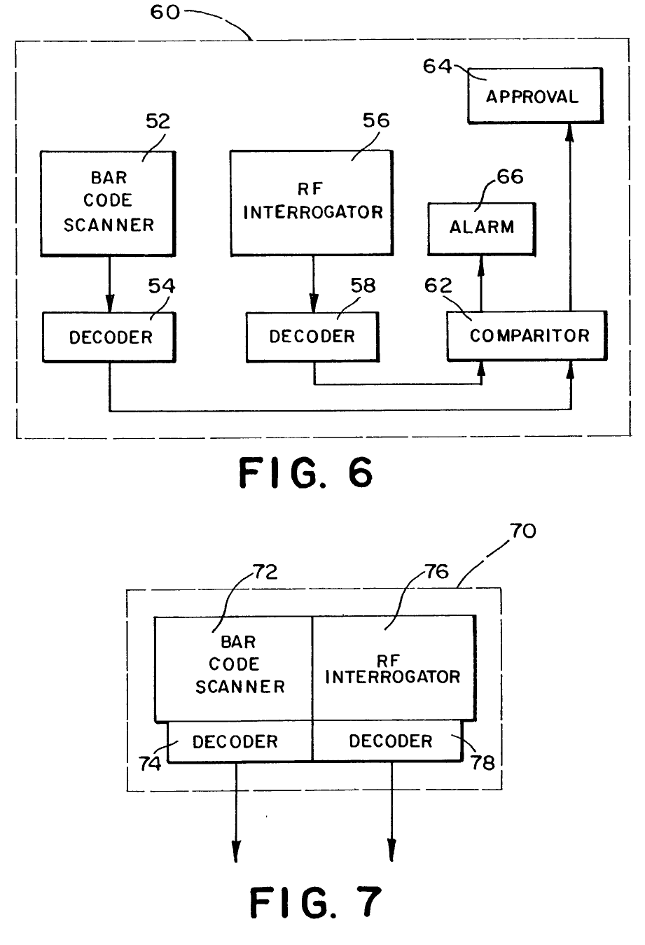

FIG. 6 is a schematic block diagram representation of a system 60 in accordance with a preferred embodiment of the present invention. The system 60 is of a type which might be installed within a checkout counter 50. The system 60 includes a barcode scanner 52 which serves as a first reader of a type well known to those of ordinary skill in the art and an associated decoder 54 also well known to those of ordinary skill in the art. The system 60 further includes a radio frequency interrogator 56 which serves as a second reader and an associated decoder 58 both of which are well known to those of ordinary skill in the art. Finally, the system 60 includes a comparitor 62 for receiving output signals from the decoders 54, 58 and performing a comparison. The comparison can be made in a variety of ways including a direct comparison of the output signals, comparing each of the signals from the decoders 54 and 58 to a predetermined database or in any other matter well known to those of ordinary skill in art. The function of the comparitor 62 is to determine whether the identity of the item as read by the barcode scanner 52 from the barcode label 14, 42 is the same as the identity of the item as read by the radio frequency interrogator 56 from the radio frequency identification tags 16, 44. If the comparison is positive, indicating a match, the comparitor 62 sends a positive output signal indicating approval 64. If the comparison is negative, indicating no match, an output signal from the comparitor is sent to an alarm 66. The alarm may be a silent alarm, a visual alarm or any other suitable alarm or indicator.

FIG. 7 illustrates a slightly different embodiment of the system 70 in which the barcode scanner 72, radio frequency interrogator 76 and the associated decoders 74, 78 are all contained within a single integrated housing.

Typically, at a clerk operated or self-operated checkout counter 50, the barcode label 14, 42 on a product or the packaging for a product is scanned for pricing purposes. If the barcode label 14, 42 on the product or its packaging is consistent with the product itself then the scanning of the barcode label results in the correct pricing of the product at the checkout counter 50. On the other hand, if the barcode label 14, 42 is not correct for the particular product being purchased or if a scanning error occurs, then the pricing of the product at the checkout counter 50 will be wrong. There are many reasons why the barcode label 14, 42 on a product or its packaging could be incorrect. A principal reason is that a thief has intentionally altered or replaced the correct barcode label 14, 42 with a different barcode label, typically of an item having a lower price. With the present invention, the secondary identifier 16, 44 located within or on the product is read slightly before, slightly after or simultaneously with the reading of the barcode label 14, 42 at the checkout counter 50. The reader 56 used for reading the secondary identifier 16, 44 is located close to the barcode scanner 52 to facilitate substantially concurrent reading of the secondary identifier 16, 44 with the reading of the barcode label 14, 42. The decoded information from both readers is sent to a comparator 62 for comparison purposes with a database. If the database shows that the product identified by the barcode label 12, 42 is the same as the product identified by the secondary identifier 16, 44 then the checkout process may continue unimpaired. However, if the decoded barcode label 12, 42 identifies a product and the decoded secondary identifier 16, 44 identifies a different product then the system provides an output alarm signal to alert either the checkout clerk, security personnel or someone else so that appropriate action may be taken. If desired, a separate electronic article security tag could be secured to the item. The electronic article security tag could be disabled at the checkout counter in a manner well known to those of ordinary skill in the art.

Another embodiment for retail sales can include the use of a loyalty card identifier, which provides a unique identification of the customer. The loyalty card identifier allows the recording in a database of the customer and each primary and secondary item identifier. This information could be used to provide direct sales or marketing data and determine purchasing profiles of the customer.

2. Event Ticket

Many event tickets, particularly relatively high-priced tickets, such as rock concerts, ice hockey games and the like include a barcode label with the barcode label information relating to the date, time and place of the event or other such information. FIG. 3 shows such an event ticket 30 with a barcode label 32. When a person having a ticket 30 approaches a gate at the location at which the event is to be held, the barcode label 32 on the person's ticket is optically scanned using a well known scanner to confirm that the ticket is valid for the particular event, date, time, and the like. In some instances, thieves have been known to produce counterfeit event tickets having a proper barcode label for the purpose of gaining admittance to an event. It is difficult, if not impossible, for a standard barcode reader to differentiate between an authentic ticket and a counterfeit ticket. With the present invention, a secondary identifier in the form of a radio frequency tag 34 is positioned either between the layers of a paper or polymeric ticket 30 or at some other inconspicuous location on the ticket 30. When a person having a ticket 30 seeks admission to an event, both the barcode label 32 and the secondary identifier 34 are substantially concurrently read (in the same manner as described above) at the gate with the decoded information from both readers being instantaneously compared to information within a database to confirm the authenticity of the ticket. If the comparison of both the barcode label 32 and the secondary identifier 34 indicates a match, and the ticket is authentic and the person is admitted to the event. If no secondary identifier 34 is read or if the information read from the secondary identifier 34 deviates from the information read from the barcode label 32 then the person would be denied admittance to the event.

3. Access Card

FIG. 2 illustrates a further preferred embodiment of the present invention in the form of an access or access control card 20. Such access control cards 20 are well known to those of ordinary skill in the art and typically include on a first principal surface certain indicia including possibly a picture 22 and name and other information 24 of the holder of the access card 20. The access card 20 further includes a primary identifier, in this case a magnetic stripe 26 which is usually located on either the front or rear principal surface of the card 20. It will be appreciated by those of ordinary skill in the art that other types of primary identifiers including a barcode could alternatively be employed on the access card 20. Typically, a magnetic stripe 26 includes certain encoded information about the identity of the holder. As is well known to those of ordinary skill in the art access to a particular location, an account or the like may be obtained by simply swiping the access card 20 through a magnetic card reader (not shown). In some cases, the information stored within a magnetic stripe 26 may be altered to permit access to a user who is not truly authorized access. In accordance with the present invention, a radio frequency identification tag 28 functioning as a secondary identifier is applied to the rear surface of the access control card 20 or is embedded within the polymeric material employed for making the access control card 20. The radio frequency identification tag 28 includes encoded information which may be read at the same time the magnetic stripe 26 is read such that the primary identification information from the magnetic stripe 26 and the secondary identification information from the radio frequency identification tag 28 may be compared in the manner as described above for making a determination with respect to whether the holder of the card 20 should be given access. The use of both a primary identifier 26 and a secondary identifier 28 makes it more likely that the access card 20 is valid.

Preferably, the secondary identifier associated with an item is unique or at least partially unique. For example, all televisions of a particular model and manufacturer may have the same partially unique secondary identifier so that, when read, the secondary identifier would confirm the model and manufacturer of the television. Alternatively, the secondary identifier may be completely unique. For example, each televisions of a particular manufacturer would have its own unique secondary identifier which could be related to a serial number of the television. Alternatively, the secondary identifier could be unique to a particular retailer and semi unique with respect to a particular product. For example, all televisions of a particular model and manufacturer, which are consigned to a particular retailer (Sears) might have secondary identifiers having a first code with televisions of the same model and manufacturer which are consigned to a different retailer (Circuit City) each having secondary identifiers with a second code. Other variations with regard to the code employed within a secondary identifier will be apparent to those of ordinary skill in the art.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention.

1. A method for automated verification of the correctness of the identity of an item which has an associated primary identifier of a first machine readable type, the method comprising the steps of:
associating a separate, secondary identifier with the item prior to the time that verification of the correctness of the identity of the item is sought, the secondary identifier being of a second, machine readable, non-contact type;
reading the primary identifier using a machine to provide primary identification information;
reading the secondary identifier using a machine to provide secondary identification information;
comparing the primary identification information and the secondary identification information; and
confirming the identity of the item only if the comparison results in a match.

2. The method as recited in claim 1, wherein the primary identifier is comprised of a barcode.

3. The method as recited in claim 2, wherein the secondary identifier is comprised of one of a radio frequency identification tag, a radio frequency tag and a magnetic tag.

4. The method as recited in claim 1, wherein the secondary identifier is associated with the item at an undisclosed, non-apparent location.

5. The method as recited in claim 1, wherein the secondary identifier is located on or within the item or packaging of the item.

6. The method as recited in claim 1, wherein the secondary identifier is associated with the item during production of the item.

7. The method as recited in claim 1, wherein the steps of reading the primary identifier and reading the secondary identifier take place substantially concurrently.

8. The method as recited in claim 1, wherein the primary identifier and the secondary identifier are read by a single integrated unit.

9. The method as recited in claim 1, further comprising activation of a device upon confirmation of the identity of the item.

10. The method as recited in claim 1, further comprising granting access to a user upon confirmation of the identity of the item.

11. The method as recited in claim 1, further comprising activation of an alarm if the identity of the item is not confirmed.

12. A system for automated verification of the identity of an item which has an associated primary identifier of a first machine readable type and a separate, secondary identifier of a second machine readable, non-contact type, the system comprising:
a first reader for reading the primary identifier and generating an output signal containing primary identification information;
a second reader for reading the secondary identifier and generating an output signal containing secondary identification information; and
a comparitor for receiving and comparing the output signal from the first reader and the output signal from the second reader and for generating an output signal based upon the result of the comparison.

13. The system as recited in claim 12, further comprising an alarm for receiving the output signal from the comparitor, the alarm being activated in the absence of a match during the comparison.

14. The system as recited in claim 12, further comprising an access control device for receiving the signal from the comparitor for activation only when the comparison indicates a match.

15. An item, including an associated primary identifier of a first machine readable type and an associated secondary identifier of a second, machine readable, non-contact type, the secondary identifier being associated with the item at an undisclosed, non-apparent location on or within the item or packaging of the item, whereby verification of the correctness of the identity of the item may be obtained by reading the primary identifier using a machine to provide primary identification information, reading the secondary identifier using a machine to provide secondary identification information and comparing the primary identification information and the secondary identification information to confirm the identity of the item only if the comparison results in a match.
